(19) United States
(12) Patent Application Publication
(10) Pub. No.: US 2024/0284838 A1
(43) Pub. Date: Aug. 29, 2024

(54) TREE CUTTING APPARATUS WITH INTEGRAL HERBICIDE SPRAYING APPARATUS

(71) Applicants: RONALD J. LAPELLE, TULSA, OK (US); WESTLY CARTER, TULSA, OK (US)

(72) Inventors: RONALD J. LAPELLE, TULSA, OK (US); WESTLY CARTER, TULSA, OK (US)

(21) Appl. No.: 18/581,721

(22) Filed: Feb. 20, 2024

Related U.S. Application Data
(60) Provisional application No. 63/447,760, filed on Feb. 23, 2023.

(51) Int. Cl. A01G 23/091; A01M 7/00

(52) U.S. Cl. CPC A01G 23/091; A01M 7/0042

(57) ABSTRACT

Taught herein is an improvement over existing mechanisms for cutting down trees. According to one embodiment the instant invention is a tree cutter that is mountable on a skid loader or similar piece of heavy equipment. The tree cutter includes an integral liquid sprayer system that can be activated by the operator of the vehicle to which it is attached. In some embodiments the liquid that is dispensed is a herbicide that can be applied to the tree that has just been felled in order to make certain that it will not produce shoots that can potentially grow to replace the tree that had just been cut. It is therefore a general object of the present invention to provide an improved dual action tree cutting apparatus that also provides for application of a herbicide by the operator without stopping the rotation of the cutting blade or exiting the vehicle.

### CROSS REFERENCE TO RELATED APPLICATIONS

This application claims the benefit of U.S. Provisional Patent Application Ser. No. 63/447,760 filed on Feb. 23, 2023, and incorporates the full disclosure of provisional application by reference into this document as if fully set out at this point.

### TECHNICAL FIELD

The instant invention relates generally to apparatus for cutting trees and, more particularly, to an apparatus with an integral herbicide spraying dispenser.

### BACKGROUND

Various apparatus for felling trees are well known. Examples include chain saws, rotary blades such as circular saws, and shear severing devices. Chain saws are subject to frequent failure because of the number of moving parts. Circular saws, while typically stronger and more robust, are also more bulky. In addition, both chain saws and circular saws run at high speeds, with the attendant hazard from flying chips and debris. Shear severing devices require enormous amounts of power and leverage to fell trees having a diameter of more than a mere few inches.

Marshall in U.S. Pat. No. 5,479,971 (“Marshall”, hereinafter), the disclosure of which is fully incorporated herein by reference as if full set out at this point, invented a dual action tree cutting apparatus (“tree cutter” hereinafter) which has a single planar blade mounted on a shaft at the forward end of a support frame. The blade has a cutting edge that extends around its forward perimeter, and has two mirror image halves divided by a centerline passing through the shaft. The blade has teeth that are configured so that a first set of teeth are situated on one blade half and are oriented to cut into a tree when the blade is rotated clockwise, while a second set of cutting teeth are oriented on the second blade half to cut into a tree when the blade is rotated counterclockwise. A sprocket attached to the shaft is engaged by a single drive chain or a pair of drive chains that are connected to hydraulic cylinders, the cylinders operate to alternatively retract and pull the piston shaft back the drive chain(s) to rotate the blade in a clockwise and then in a counterclockwise direction. Note that the term “planar” as used herein should be broadly interpreted to cover instances where the blade might not be perfectly planar, e.g., it might slightly convex or concave.

One problem that is frequently encountered when cutting trees is that after the tree is cut down for some time shoots will tend to appear proximate to the trunk that can potentially grow to replace the tree just cut. Spraying herbicide on the tree stump can reduce or eliminate this problem. However, doing that requires stopping the operation of the saw and leaving the skid-loader, bobcat, or similar heavy equipment item on which the saw is mounted. Then, the operator will need to manually apply herbicide to the recently cut tree.

Thus, what is needed is a system and method that overcomes the limitations of prior art and that can provide a means for a tree saw operator to quickly apply a herbicide to the trunk of a tree just cut without leaving the vehicle.

Before proceeding to a description of the present invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

The instant invention represents an improvement and enhancement of the Marshall invention. It is a tree cutting apparatus with an integral sprayer application system that can be activated by the operator of the skid loader or other piece of heavy equipment on which the tree saw is mounted without exiting the vehicle. In some embodiments the sprayer will be configured to dispense a herbicide, although it could dispense any liquid. It is therefore a general object of the present invention to provide an improved dual action tree cutting apparatus similar to that disclosed in Marshall that also provides for application of a herbicide by the operator without stopping the rotation of the blade or exiting the vehicle.

The foregoing has outlined in broad terms some of the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1 shows a generalized view of an embodiment of the invention;

FIG. 2 shows an example detailed view of the sprayer apparatus;

FIG. 3 contains a more detail illustration of the sprayer tank integral to the frame;

FIG. 4 contains an example configuration of a sprayer nozzle apparatus; and,

FIG. 5 contains a view of the embodiment of FIG. 1 in which certain elements have been removed to make viewable structural features of the instant invention not clearly visible in

FIG. 1.

FIG. 6 contains an exploded view of a sprayer tank suitable for use with an embodiment.

The invention will be described in connection with its preferred embodiments. However, to the extent that the following detailed description is specific to a particular embodiment or a particular use of the invention, this is intended to be illustrative only and should not be construed as limiting the invention's scope. On the contrary, it is intended to cover all alternatives, modifications, and equivalents included within the invention's spirit and scope, as defined by the appended claims.

### DETAILED DESCRIPTION

While this invention is susceptible of embodiment in many different forms, there is shown in the drawings, and will be described hereinafter in detail, some specific embodiments of the instant invention. It should be understood, however, that the present disclosure is to be considered an exemplification of the principles of the invention and is not intended to limit the invention to the specific embodiments or algorithms so described.

Turning first to FIG. 1, as can be seen the general configuration of the improved tree saw 100 is structurally similar to the Marshall tree saw apparatus of U.S. Pat. No. 5,479,971. As discussed below, the instant tree saw includes additional features not present in the Marshall device.

The instant invention includes frame members 70, 24, 28, 75, 76, 80 and 85 for supporting a generally elliptical rotatable blade 10 that is horizontally mounted on the front end assembly 85 and extends beyond it. Attachment member 70 is configured to make it possible to mount the instant invention 100 on a skid loader or other piece of heavy equipment. Preferably, the attachment member 70 will contain connecting ports to receive hydraulic lines from the skid loader to which it is attached. Note that when the terms “elliptical” or “elliptical in shape” are used herein those terms refer to the general shape of the cutting edge of the blade 10, i.e., the portion that extends beyond the front end assembly 85. That portion of the blade will preferably take the form of an elongated circle that is stretched into an oval. The portion of the blade 10 that is beneath the front end assembly 85 may or may not complete the ellipse defined by the cutting edge of the blade 10.

Note that for purposes of the instant disclosure the term “skid loader” is only used as an example of the sort of heavy equipment that would be suitable to have the instant invention mounted thereon. Those of ordinary skill in the art will understand that the instant invention might be mounted on any number of other types of heavy equipment. Thus, when the term skid loader is used herein it should be broadly construed to refer to any sort of heavy equipment that would be suitable for use with the instant invention 100.

Front end assembly 85 is supported in this embodiment by center beam 80, upper 24 and lower 75 left frame members and upper right 28 and lower left 76 frame members which are in turn all mounted on attachment member 70. Attached to the foremost portion of the front end assembly 85 is a toothed tree gripping member 110 that is designed to engage the trunk of the tree that is being cut and keep the tree saw 100 in contact with the tree while the blade 10 is cutting. The instant tree saw 100 preferably includes deflecting member 22 which is supported by left and right struts 20 which, in this embodiment, extend between the deflecting member 22 to the front-end assembly 85. The deflecting member 22 is provided to deflect falling trees away from the back of the tree saw 100 and, preferably, will also provide some level of protection for the operator of the machine. Thus, preferably it will be sturdy enough to withstand impacts from tree trunks and branches that are cut or otherwise fall from a target tree.

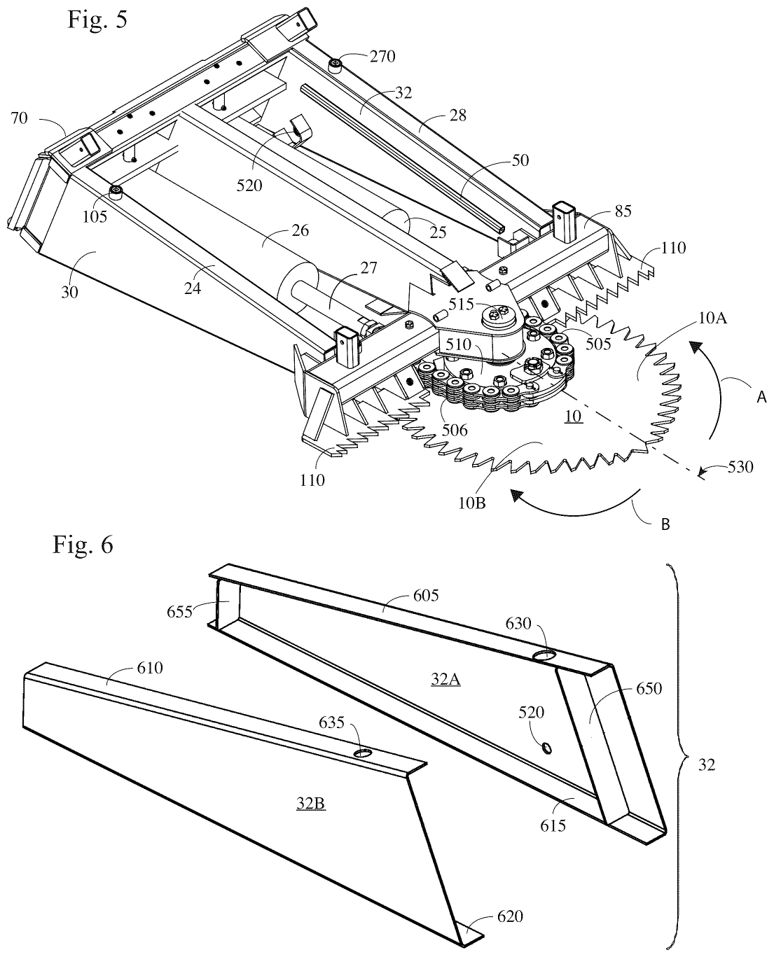

In some embodiments and as is indicated in Marshall, the blade 10 will preferably be mounted on a shaft (not shown) contained within the blade assembly 95. An upper shaft cap 515 associated with the shaft is visible in FIGS. 1 and 5. The shaft is mechanically connected to a sprocket 510 also within the blade assembly 95 that is engaged by left 506 and right 505 drive chains that are in mechanical communication with the shafts associated with piston assemblies 25 and 26 (FIG. 5). Note that, as is disclosed in Marshall, the preferred blade shape is roughly elliptical in shape and in FIG. 5 it is longitudinally elongated in a direction perpendicular to the front end assembly 85, i.e., its major axis is perpendicular to the front end assembly. The shaft to which the blade 10 is attached is situated along its center line 530 closer to the rear of the blade 10 than to the front, where the “front” of the blade 10 refers to the portion of the blade furthest from the front-end assembly and which extends beyond it. This mounting point creates a non-central axis of rotation and introduces a sweeping action to the blade 10 when it is rotated back and forth.

Blade 10 is supported by front end assembly 85 and is urged in alternately clockwise and counterclockwise directions by piston assemblies 25 and 26 which pull chains 505 and 506 and rotate the blade 10 in opposite directions when they retract their associated piston shafts.

The blade 10 of the instant invention is functionally similar to the one illustrated in Marshall and is preferably designed to be operated in a reciprocal manner, rotating first in one direction and then in the reverse direction while it cuts. In more particular, and as is illustrated in FIG. 5, the blade 10 has teeth that are configured differently on each side of a center line 530 that extends orthogonal to the front end assembly 85 and bisects the blade into left 10B and right 10A halves. A first set of cutting teeth situated on the left half 10B of blade 10 are configured to cut into a tree when the blade is rotated clockwise (direction “B”), while a second set of cutting teeth are situated on the right half 10A of blade 10 and are configured to cut into a tree when the blade is rotated in the opposite direction (direction “A”). In some preferred arrangements, the teeth are formed via a broaching process.

Piston assemblies 25 and 26 are in reciprocal mechanical communication via drive chains 505 and 506 with the sprocket 510 which supports the blade 10. The pistons are preferably activated by hydraulic pressure supplied by the skid loader via ports (not shown) in the attachment member 70. Pistons and drive chain are configured to rotate the blade 10 first in one direction and then the other as the pistons are alternatively retracted and extended. Retraction of left and right piston assemblies 25 and 26 induce opposite rotational directions in the blade 10 when they retract. That is, retraction of left piston shaft 27 will be accompanied by a corresponding extension of the piston shaft (not shown) of piston assembly 25 and rotation of the blade 10 in a clockwise direction (i.e., direction “B” in FIG. 1). Similarly, retraction of the piston shaft associated with right piston 25 will be accompanied by extension of piston shaft 27 and rotation of the blade 10 in an opposite direction, i.e., counterclockwise or direction “A” in FIG. 1.

Other configurations that, say, involve a single drive chain that connects the two piston shafts to the blade sprocket are well known to those of ordinary skill in the art and are well within the ability of such an individual to devise. Marshall provides one such example.

In this particular case, two spray pump housings 200 and 202 are provided to contain and protect two spray pumps which each draws from its own spray tank 30 and 32, respectively. Note that this is a preferred configuration, and in some embodiments, only a single housing and its associated spray pump might be provided.

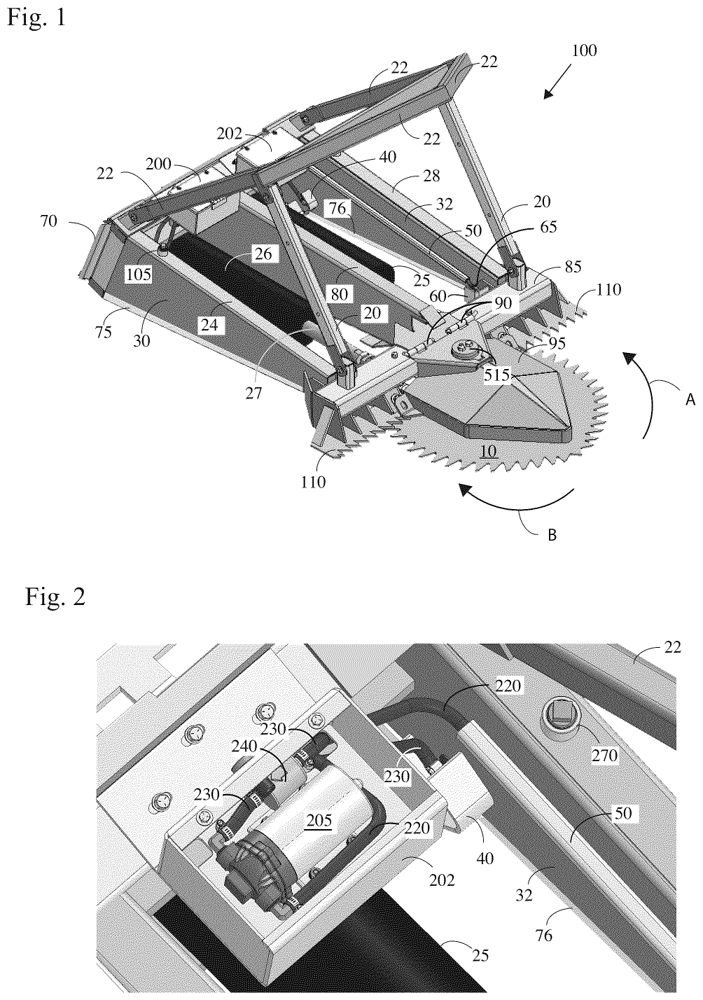

In FIG. 2, spray pump 205 draws from spray tank 32 via tank access line 230 and sends its contents to a spray nozzle situated proximate to the front of tree saw 100. The entry point of tank access line 230 is protected by bracket 40. Spray nozzle 65 is identified in FIG. 1, as is its protection bracket 60 which serves to shield the nozzle against damage from the limbs, branches, trunks, etc., of the trees that are felled by the instant tree saw 100. The corresponding spray nozzle on the other side of the front-end assembly 85 that is utilized in this embodiment is not visible. Supply hose guard 50 is provided to protect the supply line 230 that extends from the pump 205 to the nozzle 410 (FIG. 4) via connector 65.

In some embodiments the capacity of the spray tanks 30 and 32 might be 6 gallons (US) or 1400 cubic inches or 24 liters. That being said, those of ordinary skill in the art will recognize that the volume of the tank can readily be adjusted to suit the particular application. Additionally, it should be noted that the discussion above also applies to the pump contained within housing 200 that draws from tank 30 and its connections to its own spray nozzle (not shown) mounted on the front-end assembly 85. Note that in some embodiments, the tanks 30 and 32 might have double thick walls which would serve to help protect them against damage while the tree saw is in operation. This configuration would be particularly useful in reinforcing the tanks and would also tend to serve to buttress the associated frame members.

What is particularly important for purposes of the instant invention is that the spray tanks 30 and 32 are situated between, and integral to, the frame members 24/75 and 25/76, respectively. This arrangement provides each pump ready access to each tank's contents via its associated supply line (e.g., supply line 230). This arrangement provides some additional strength to the support members and also provides some protection to the tanks against falling or fallen debris

FIG. 2 contains additional details of an embodiment. As can be seen, the spray pump 205 is contained within the spray pump housing 202 which is mounted on the frame of the tree saw 100. The supply line 230 draws fluid from the tank 30 and, in this example, the fluid passes through filter 240 before its contents reaches the pump 205. The pump then sends the liquid under pressure through spray line 220 which enters protection bracket 50 and emerges at the other end to engage spray nozzle 65. (FIG. 4).

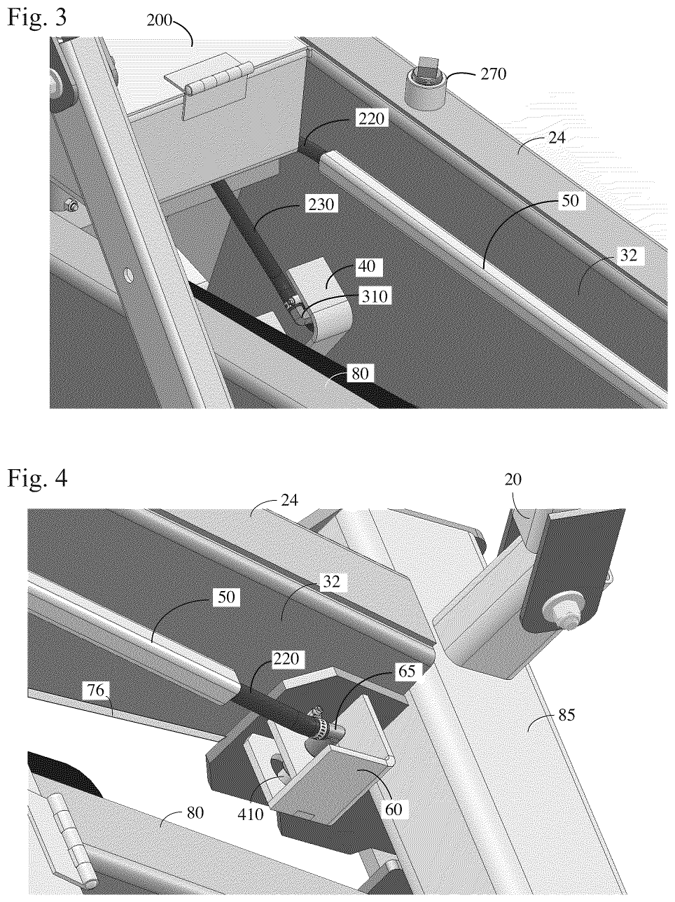

Turning next to FIG. 3, the supply line 230 draws fluid from the associated tank 32 via connector 310 which is protected by bracket 40. Additionally, the spray tank fill ports 270 (FIGS. 2) and 105 (FIG. 1) are situated to make it easy to fill the associated tank 32.

FIG. 4 illustrates one configuration of the sprayer nozzle 410. As can be seen, the spray supply line 220 emerges from the supply hose guard 50 and connects with downward terminating connector 65 which is attached to nozzle 410. As is illustrated, the connector 65 and nozzle 410 are both preferably protected by spray nozzle protection bracket 60.

The spray pump 210 is provided with electrical lines (not shown) that are in electrical communication with an on-off switch preferably located in the cab of the skid loader. In the event that there are two mounted spray pumps 210, two sets of electrical lines will extend from the back plane of the attachment member 70 of the saw 100 and be in electrical communication with one or two switches in the cab of the attached vehicle.

Finally, and turning now to FIG. 6, in this figure, and according to one embodiment, is a sprayer tank 32 suitable for use with an embodiment. In this exploded view, sidewalls 32A and 32B comprise, respectively, the interior wall and exterior wall of the tank 32, where “interior” means the tank wall that faces the spray pump housing 202 and “exterior” means the wall of the tank 32 that faces away from the spray pump housing 202 and toward the exterior of the saw 100. The two halves of the tank 32A and 32B are designed to be welded together to form the tank 32. In this particular case, the bent portions 605/610 and 620/615 of each wall will be brought together and overlapped to form the frame members 24 and 28, respectively, the double thickness of the overlapping tank halves providing additional stiffness and support to the front end of the device 100. That is, frame member 28 is comprised of the overlapped bent portions 605 and 610. Similarly, overlapped bent portions 615 and 620 are preferably welded together to form lower left frame member 76. Finally, internal plates 650 and 655 have been added to provide additional strength to the tank 32.

Obviously, one or more of frame members 24, 25, 75, and 76 could be separate beams that are attached (preferably by welding) to the tanks 30 and 32 instead of being formed from overlapping portions of the tank sidewalls. Those sorts of design decisions are well within the ability of one of ordinary skill in the art to make.

As can be seen in FIG. 6, the wall 32A also contains an aperture 520 to which connector 310 can be attached so that fluid may be drawn from the tank 32. Note also that in this embodiment, when walls 32A and 32B are brought together and the associated folded regions 605 and 610 overlapped, apertures 630 and 635 will be made coincident and provide access for tank fill port 270 to the interior of the tank 32. As is illustrated in FIG. 6, it some cases the aperture 630 might be made slightly larger than aperture 635 to make it easier to make them coincident and install tank fill port 270 after the two halves of the tank 32A and 32B are brought together during tank assembly.

It should be noted and understood that the invention is described herein with a certain degree of particularity. However, the invention is not limited to the embodiment(s) set forth herein for purposes of exemplification, but is limited only by the scope of the attached claims.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

The singular shall include the plural and vice versa unless the context in which the term appears indicates otherwise.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Still further, additional aspects of the instant invention may be found in one or more appendices attached hereto and/or filed herewith, the disclosures of which are incorporated herein by reference as if fully set out at this point.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A tree cutting apparatus and sprayer, comprising:
(a) a rectangular support frame comprising:
(a1) a forward front-end assembly,
(a2) a rearward attachment member, said rearward attachment member being adapted to be engaged by a skid loader,
(a3) a left side upper frame member and a left side lower frame member at least for supporting said front end assembly, said left side upper and lower frame members being supported by said rearward attachment member at a left first end and terminating at a left second end at said front end assembly;
(a4) a right side upper frame member and a right side lower frame member at least for supporting said front end assembly, said right side upper and lower frame members being supported by said rearward attachment member at a right first end and terminating at a right second end at said front end assembly;
(b) a horizontal planar tree cutting blade rotatably mounted on said front end assembly, said blade having a front edge and a rear edge, wherein said front edge comprises an arcuate cutting edge extending beyond said front end assembly;
(c) first and second pistons mounted within said frame and in reciprocal mechanical communication with each other, said first piston having a first shaft in mechanical communication with said blade and said second piston having a second shaft in mechanical communication with said blade, wherein
(c1) retraction of said first shaft rotates said blade in a first direction and is accompanied by an extension of said second shaft, and,
(c2) retraction of said second shaft rotates said blade in a direction opposite said first direction and is accompanied by an extension of said first shaft;
(d) a tank integral to and situated between either said left side upper frame member and said left side lower frame member, or said right side upper frame member and said right side lower frame member;
(e) a pump mounted on said frame and in hydraulic communication with an interior of said tank, said pump at least for drawing a liquid from said tank and urging the liquid into a supply hose that terminates in a nozzle mounted on said front end assembly.

2. The tree cutting apparatus of claim 1, wherein said blade is elliptical.

3. The tree cutting apparatus of claim 1, wherein said blade has an axis of rotation that is located nearer said rear edge than said front edge.

4. The tree cutting apparatus of claim 1, wherein said arcuate cutting edge of said blade comprises left and right cutting edges defined by a center line running longitudinally through said blade and wherein said left cutting edge comprises a plurality of teeth that are configured to cut into a tree when said blade is rotated in said first direction and wherein said right cutting edge comprises a plurality of teeth that are configured to cut into the tree when said blade is rotated in said second direction.

5. The tree cutting apparatus of claim 1, further comprising
(f) a tree gripping member mounted on the forward end of said frame for engaging with a trunk of the tree and preventing transverse sliding movement of the tree away from the blade when the blade is rotated to cut the tree.

6. The tree cutting apparatus of claim 1, further comprising
(f) a deflecting member mounted atop said frame, said deflecting member at least for deflecting falling tree limbs and tree trunks away from said frame.

7. A dual action tree cutting apparatus and sprayer, comprising:
(a) a rectangular support frame having a forward frame member, a rearward frame member, a left frame member and a right frame member, wherein
(a1) said rearward frame member is adapted to be engaged by a skid loader
(a2) said left frame member comprises a left upper frame member and a left lower frame member, said left upper and lower frame members being attached at a left first end on said rearward frame member and supporting said front frame member on a left second end,
(a3) said right frame member comprises a right upper frame member and a right lower frame member, said right upper and lower frame members being attached at a right first end on said rearward frame member and supporting said front frame member on a right second end;
(b) a horizontal planar tree cutting blade rotatably mounted on said forward frame member, said blade having a front edge and a rear edge, wherein said front edge comprises an arcuate cutting edge extending beyond said forward frame member;
(c) a sprocket attached to said blade;
(d) first and second pistons mounted within said frame and in reciprocal mechanical communication with each other, said first piston having a first shaft in mechanical communication with said sprocket and said second piston having a second shaft in mechanical communication with said sprocket, wherein
(d1) retraction of said first shaft rotates said blade in a first direction and is accompanied by an extension of said second shaft, and,
(d2) retraction of said second shaft rotates said blade in a direction opposite said first direction and is accompanied by an extension of said first shaft;
(e) a left sprayer tank integral to said support frame and situated between said left upper structural member and said left lower structural member;
(f) a right sprayer tank integral to said support frame and situated between said right upper structural member and said right lower structural member;
(g) a left sprayer nozzle attached to said forward frame member;
(h) a right sprayer nozzle attached to said forward frame member;
(i) a left sprayer pump attached to said rearward frame member and in hydraulic communication with said left sprayer tank and said left sprayer nozzle, said left sprayer pump at least for drawing liquid from said left sprayer tank and dispensing it through said left sprayer nozzle; and,
(j) a right sprayer pump attached to said rearward frame member and in hydraulic communication with said right sprayer tank and said right sprayer nozzle, said right sprayer pump at least for drawing liquid from said right sprayer tank and dispensing it through said right sprayer nozzle.

8. A dual action tree cutting apparatus and sprayer according to claim 7, wherein said first and second pistons further comprise:
(i) a first chain connected to said first piston shaft and engaged with said sprocket on a first side of said sprocket, and
(ii) a second chain connect to said second piston shaft and engaged with said sprocket on a side of said sprocket opposite said first side.

9. The tree cutting apparatus of claim 7, wherein said blade is elliptical in shape.

10. The tree cutting apparatus of claim 7, wherein said blade has an axis of rotation that is located nearer said rear edge than said front edge.

11. The tree cutting apparatus of claim 7, wherein said arcuate cutting edge of said blade comprises left and right cutting edges defined by a center line running longitudinally through said blade and wherein said left cutting edge comprises a plurality of teeth that are configured to cut into a tree when said blade is rotated in said first direction and wherein said right cutting edge comprises a plurality of teeth that are configured to cut into the tree when said blade is rotated in said second direction.

12. The tree cutting apparatus of claim 7, further comprising
(k) a tree gripping member attached to the forward frame for engaging with a trunk of a tree and preventing a transverse sliding movement of the tree away from the blade as the blade is rotated to cut the tree.

13. The tree cutting apparatus of claim 7, further comprising
(k) a deflecting member mounted atop said frame, said deflecting member at least for deflecting falling tree limbs and tree trunks away from said frame.
